(19) United States
(12) Patent Application Publication
(10) Pub. No.: US 2015/0381314 A1
(43) Pub. Date: Dec. 31, 2015

(54) WIRELESS DEVICE

(71) Applicant: MITSUBISHI ELECTRIC CORPORATION, Chiyoda-ku, Tokyo (JP)

(72) Inventor: Toshiaki TOMISAWA, Tokyo (JP)

(73) Assignee: Mitsubishi Electric Corporation, Chiyoda-ku, Tokyo (JP)

(21) Appl. No.: 14/769,277

(22) PCT Filed: Dec. 3, 2013
(86) PCT No.: PCT/JP13/82473

§ 371 Date: Aug. 20, 2015

(30) Foreign Application Priority Data
Feb. 20, 2013 (JP) 2013-031166

(51) Int. Cl. H04L 1/00; H04L 1/18; H04L 12/18; G06F 11/10

(52) U.S. Cl. CPC H04L 1/0041; G06F 11/10; H04L 1/1896; H04L 12/189

(57) ABSTRACT

A wireless device that can realize a low delay while ensuring reliability when FEC is applied to multicast communication via a wireless LAN. The wireless device includes a correction-coding consecutive-transmission determination unit that determines as to which of correction-coding and consecutive-transmission of information packets should be transmitted based on communication state with a packet destination terminal, a packet identification accumulation unit that identifies and accumulates information packets acquired from the correction-coding consecutive-transmission determination unit, a correction-coding control unit that performs correction coding and correction decoding of information packets acquired from the packet identification accumulation unit, and a consecutive-transmission control unit that duplicates and complements the information packets acquired from the packet identification accumulation unit .

### FIELD

The present invention relates to a wireless device that executes FEC control.

### BACKGROUND

In recent years, use of multicast that provides concurrent transmission to many terminals to transfer a moving image has been demanded. However, when a 2.4 GHz ISM (Industry Science Medical) band of a wireless LAN (Local Area Network) is employed, there are many interference sources and environments are often poor. In multicast communication via the wireless LAN, no delivery acknowledgement is issued unlike in unicast communication and thus transmission is performed at the lowest rate (1 Mbps) to ensure arrival of data.

As methods for transferring data at a high speed rather than at the lowest rate, there are a method of converting multicast into unicast and then transferring data at a high rate and a method of increasing the rate of multicast. However, these methods have the following problems, respectively. First, in the method of converting multicast into unicast, the efficiency is low when there are many terminals that receive data. When the rate is simply increased, reliability as high as that of the unicast cannot be provided. To increase the reliability, a method of consecutively transmitting data is used, and such a method is disclosed in Patent Literature 1 listed below, for example.

As a means for solving the above problems, an error-correction encoding system is known. As the error-correction encoding system, there are two known types, that is, FEC (Forward Error Code) and ARQ (Automatic Repeat request). ARQ or a combination of FEQ and ARQ can enhance the arrival rate of data. However, once an error occurs, the delay time increases due to retransmission. Accordingly, the combination of FEC and ARQ is unsuitable for a case where data is to be transmitted to many terminals concurrently with a low delay and a method using only the FEC is more effective.

Specifically, as a technique in which FEC is applied to a network, Patent Literature 2 listed below discloses a technique of applying FEC to, for example, a notification signal for a vehicle, which is difficult to be retransmitted or consecutively transmitted. Patent Literatures 3 to 5 listed below disclose techniques that enable to add erasure correction to bulk data for video image and then transmit the data to a transmission channel (including both wireless channel and wired channel).

Generally, in a case in which FEC is applied to a wireless LAN, the total number of packets is k+n when the number of information packets is k and the number of coded packets is n. In the case of consecutive transmission, the total number of packets is k×h when the number of information packets is k and the number of consecutive transmissions is h. Non Patent Literature 1 listed below discloses a result that the consecutive transmission requires a larger delay time to ensure the same PER (Packet Error Rate) in a wireless LAN.

### CITATION LIST

### Patent Literatures

Patent Literature 1: Japanese Patent Application Laid-open No. 2010-010858

Patent Literature 2: Japanese Patent Application Laid-open No. 2009-188585

Patent Literature 3: Japanese Patent Application Laid-open No. 2009-027720

Patent Literature 4: Japanese Patent Application Laid-open No. 2009-055603

Patent Literature 5: International Publication No. WO02010/001610

### Non Patent Literature

Non Patent Literature 1: Suzuki, Ueno, Ishikawa, Takahashi, Satoh, Mizuno: “Performance Analysis of Hybrid Error Recovery Methods for Reliable Multicast in Wireless Networks”, Transactions of Information Processing Society of Japan, pp 2497-2505, Vol. 45 No. 11, November 2004.

### SUMMARY

### Technical Problem

The conventional technique (Non Patent Literature 1) listed above premises that the k information packets always come at fixed intervals. However, when transmission is performed via a network including a wireless LAN, a fixed quantity of information packets does not always come and thus it is necessary to wait for a certain time to ensure the number of information packets. Furthermore, when the fixed number of information packets cannot be ensured, influences on the transfer performance, such as performing processing of forcedly generating coded packets by inserting dummy data, are increased and also the delay is increased.

Setting of the number of information packets and the like in Non Patent Literature 1 is described here without considering the necessity of waiting for information packets for a certain time, insertion of dummy data, or the like when the number k of information packets is short. In the case of FEC, the total number of packets is k+n when the number of information packets is k and the number of coded packets is n. When k=20 and n=128 are set assuming that information is insufficient, the total number of packets is 148. Meanwhile, in the case of consecutive transmission, the total number of packets is k×h when the number of information packets is k and the number of consecutive transmissions is h. When k=20 and h=5 are set similarly assuming that information is insufficient, the total number of packets is 100. As described above, there is a case where the transfer time in the consecutive transmission is shorter than that in the FEC depending on how the number k of information packets is set or the like. That is, there is a possibility that the delay time is longer in the case of using coded packets.

The present invention has been achieved in view of the above problems and an object of the present invention is to provide a wireless device that can realize a low delay while ensuring the reliability when the FEC is applied to multicast communication via a wireless LAN.

### Solution to Problem

In order to solve the aforementioned problems, a wireless device is constructed to include: a correction-coding consecutive-transmission determination unit that determines as to which of correction-coding and consecutive-transmission of information packets should be transmitted, based on information of a communication state with a packet destination terminal; a packet identification accumulation unit that identifies and accumulates information packets acquired from the correction-coding consecutive-transmission determination unit; a correction-coding control unit that performs correction coding and correction decoding of information packets acquired from the packet identification accumulation unit; and a consecutive-transmission control unit that duplicates and complements the information packets acquired from the packet identification accumulation unit.

### Advantageous Effects of Invention

According to the wireless device of the present invention, it is possible to realize a low delay while ensuring the reliability when the FEC is applied to multicast communication via a wireless LAN.

### BRIEF DESCRIPTION OF DRAWINGS

FIG. 1 is a diagram illustrating a configuration example of a wireless device according to a first embodiment.

FIG. 2 is a diagram illustrating a configuration example of a correction-coding control unit.

FIG. 3 is a diagram illustrating a configuration example of a consecutive-transmission control unit.

FIG. 4 is a diagram illustrating a configuration example of header information added by a packet identification accumulation unit in the case of correction coding.

FIG. 5 is a diagram illustrating a configuration example of header information added by the packet identification accumulation unit in the case of consecutive transmission.

FIG. 6 is a flowchart illustrating a determination algorithm of a correction-coding consecutive-transmission determination unit according to a second embodiment.

FIG. 7 is a flowchart illustrating a determination algorithm of a correction-coding consecutive-transmission determination unit according to a third embodiment.

FIG. 8 is a flowchart illustrating a determination algorithm of a correction-coding consecutive-transmission determination unit according to a fourth embodiment.

FIG. 9 is a flowchart illustrating a determination algorithm of a correction-coding consecutive-transmission determination unit according to a fifth embodiment.

FIG. 10 is a diagram illustrating a configuration example of a wireless device according to a sixth embodiment.

FIG. 11 is a sequence diagram illustrating retransmission control by an ARQ in the wireless device according to the sixth embodiment.

### DESCRIPTION OF EMBODIMENTS

Exemplary embodiments of a wireless device according to the present invention will be explained below in detail with reference to the accompanying drawings. The present invention is not limited to the embodiments.

### First Embodiment

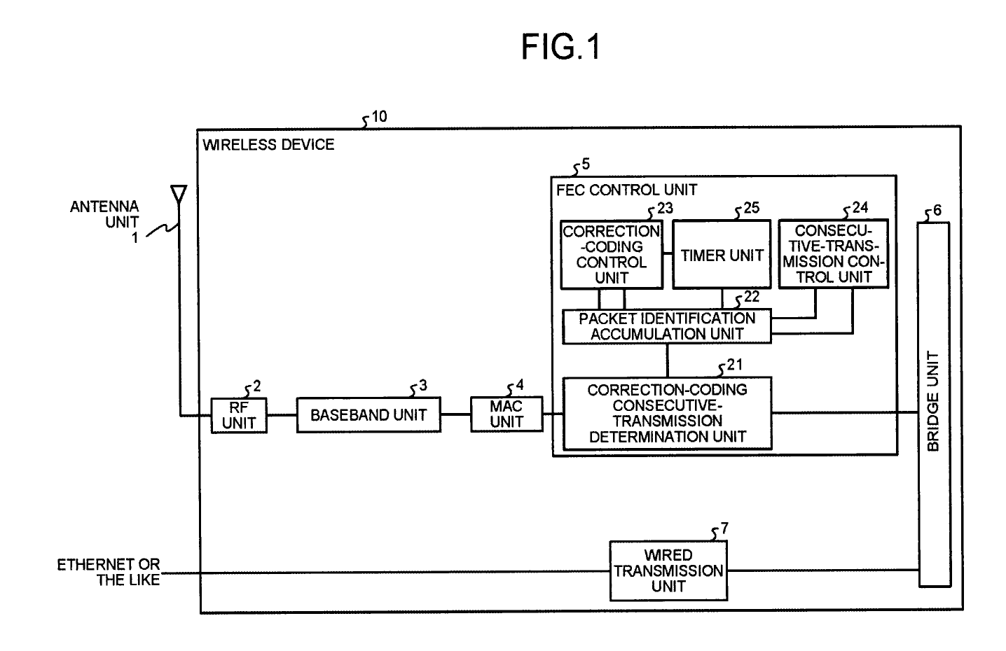

FIG. 1 is a diagram illustrating a configuration example of a wireless device that performs communication via a wireless LAN according to an embodiment of the present invention. A wireless device 10 includes an antenna unit 1 that transmits and receives a radio signal to and from multicast terminals that are terminals as packet destinations and the like, an RF (Radio Frequency) unit 2 including a PA (Power Amplifier) that amplifies a radio signal to be transmitted and an LNA (Low Noise Amplifier) that amplifies a received radio signal, a baseband unit 3 including a transmission unit that performs downlink transmission to the multicast terminals, a reception unit that performs reception from the multicast terminals, and a converting unit that converts (modulates and demodulates) an OFDM (Orthogonal Frequency Division Multiplexing) signal (a baseband signal) to be on a radio wave, a MAC (Media Access Control) unit 4 that converts a multicast packet including an information packet received by a cable line into a wireless frame and executes access control based on CSMA/CA (Carrier Sense Multiple Access/Collision Avoidance), an FEC control unit 5 that determines whether to correction-code or consecutive-transmit an information packet to be transmitted, a bridge unit 6 that transfers an information packet between the wireless LAN and a wired transmission unit 7, and the wired transmission unit 7 that receives an information packet by a cable line from the Ethernet® or the like.

The FEC control unit 5 that executes FEC control in the present embodiment is described next. The FEC control unit 5 includes a correction-coding consecutive-transmission determination unit 21 that determines regarding a multicast packet transmitted from the antenna unit 1 whether to correction-code or consecutive-transmit an information packet, a packet identification accumulation unit 22 that performs packet identification and packet accumulation regarding a packet from the correction-coding consecutive-transmission determination unit 21, a correction-coding control unit 23 that performs correction coding and correction decoding of an information packet in the case of correction coding, a consecutive-transmission control unit 24 that duplicates and complements an information packet in the case of consecutive transmission, and a timer unit 25 that measures timing for coding and decoding of an information packet.

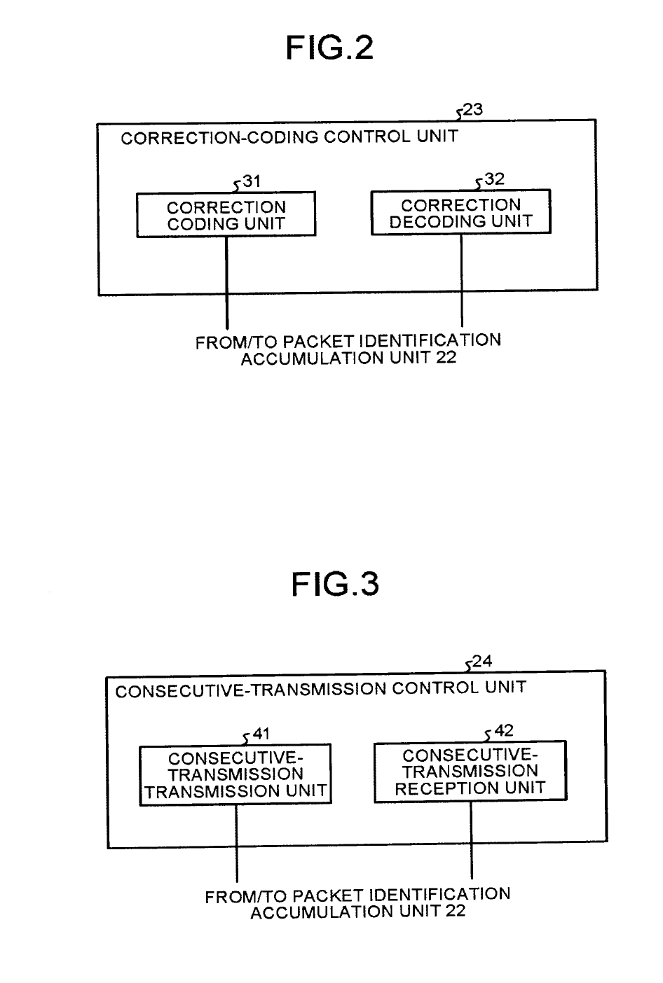

The configurations of the correction-coding control unit 23 and the consecutive-transmission control unit 24 included in the FEC control unit 5 are described next. FIG. 2 is a diagram illustrating a configuration example of the correction-coding control unit 23. The correction-coding control unit 23 includes a correction coding unit 31 that, when a desired packet error rate (PER) is determined using a Reed Solomon code, a low density parity check code (LDPC code), or the like, adds the number n of coded packets to the number k of input information packets so as to satisfy the PER, and a correction decoding unit 32 that, when there is a missing information packet, decodes the information packet using information packets and coded packets that have been received by the own wireless device.

FIG. 3 is a diagram illustrating a configuration example of the consecutive-transmission control unit 24. The consecutive-transmission control unit 24 includes a consecutive-transmission transmission unit 41 that duplicates an information packet to obtain h coded packets of the same data as that of the information packet and outputs the h coded packets, and a consecutive-transmission reception unit 42 that, when an information packet is missing, complements the missing information packet using any one of following h coded packets.

A multicast packet transmitted or received between the multicast terminals and the wireless device 10 is a packet including both an information packet and a coded packet.

The FEC control executed by the FEC control unit 5 is described next. First, the correction-coding consecutive-transmission determination unit 21 filters information packets from the bridge unit 6 under a certain condition and thereafter, when the FEC control is required, transfers the information packets together with information from the bridge unit 6 to the packet identification accumulation unit 22, and also filters multicast packets from the MAC unit 4 under a certain condition and thereafter, when the FEC control is required, transfers the multicast packets together with information from the MAC unit 4 to the packet identification accumulation unit 22. The certain condition includes, for example, checking a MAC address, an IP address, or the like so as to determine whether a multicast bit is set. However, this is an example and the condition is not limited thereto. The information to be transferred to the packet identification accumulation unit 22 is the number of information packets, a sequence number, and the like. However, this is an example and the information is not limited thereto.

The correction-coding consecutive-transmission determination unit 21 determines whether to correction-code or consecutive-transmit information packets from the bridge unit 6. The correction-coding consecutive-transmission determination unit 21 acquires information necessary for the determination, for example, statistical information of reception power at the time of reception of the multicast packets transmitted from multicast terminals as packet destinations or throughput at the time of transmission of the multicast packets to the multicast terminals from the MAC unit 4 and performs the determination (switching) based on the acquired information.

When a decoding processing is required for a multicast packet from the MAC unit 4 due to a missing information packet included in the multicast packet or the like, the correction-coding consecutive-transmission determination unit 21 determines that a decoding processing of the information packet is performed by the correction decoding unit 32 of the correction-coding control unit 23 or a complement processing of the information packet is performed by the consecutive-transmission reception unit 42 of the consecutive-transmission control unit 24. When there is no information packet missing in the packet from the MAC unit 4, the correction-coding consecutive-transmission determination unit 21 outputs the information packet included in the multicast packet from the MAC unit 4 to the bridge unit 6 because processing for decoding or complementing the information packet in the FEC control unit 5 is not necessary regardless of whether the packet has been correction-coded or consecutive-transmitted.

Next, when the correction-coding consecutive-transmission determination unit 21 determines to perform correction coding, the packet identification accumulation unit 22 performs packet identification to determine whether to perform correction-coding or correction-decoding of the packet received from the correction-coding consecutive-transmission determination unit 21. Specifically, the packet identification accumulation unit 22 outputs information packets, which are to be transmitted from the own wires device to the multicast terminals, to the correction coding unit 31 for correction coding, and outputs multicast packets, which are received by the own wireless device from the multicast terminals, to the correction decoding unit 32 for correction decoding.

The packet identification accumulation unit 22 accumulates the information packets. Subsequently, in a case where the packet identification indicates correction coding, the packet identification accumulation unit 22 inserts dummy information packets and outputs the accumulated information packets to the correction coding unit 31 when a predetermined number of information packets have been accumulated or when a timer in the timer unit 25 has expired (after a predetermined time has passed).

The packet identification accumulation unit 22 adds information necessary for decoding as a header to the multicast packet including the information packet coded by the correction coding unit 31 and the coded packet, outputs the header-added multicast packet to the correction-coding consecutive-transmission determination unit 21, and then releases the accumulated information packets. The correction-coding consecutive-transmission determination unit 21 outputs the acquired multicast packet to the MAC unit 4.

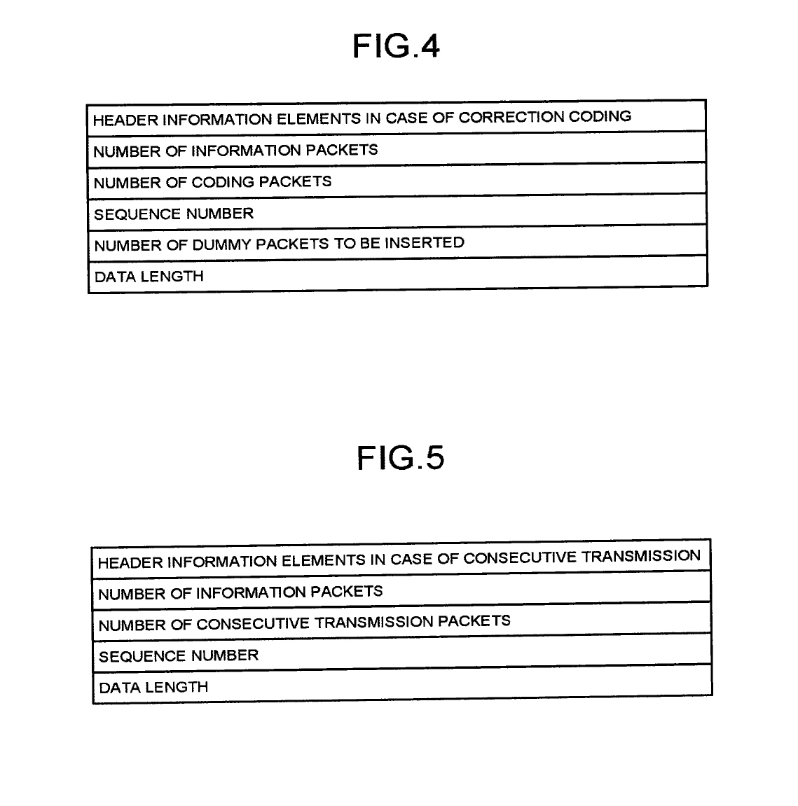

FIG. 4 is a diagram illustrating a configuration example of header information added by the packet identification accumulation unit 22 in the case of correction coding. Header information elements in the case of correction coding include the number of information packets, the number of coded packets, a sequence number to be used for ordering of packet missing, coding, and decoding, the number of dummy packets to be inserted, and the data length for adding or deleting Padding to or from variable data. The header information is required when decoding is performed in multicast terminals that have received the multicast packet.

Meanwhile, when packet identification indicates correction decoding, the packet identification accumulation unit 22 extracts information necessary for decoding, then deletes the header, and, when an information packet is missing, outputs accumulated coded packets and received (not missing) information packets together with the extracted information to the correction decoding unit 32 when a predetermined number of coded packets that are used to restore the missing information packet have been accumulated or when the timer in the timer unit 25 has expired (after a predetermined time has passed).

The packet identification accumulation unit 22 outputs the information packet decoded by the correction decoding unit 32 to the correction-coding consecutive-transmission determination unit 21. The correction-coding consecutive-transmission determination unit 21 outputs the acquired information packet to the bridge unit 6.

When the packet identification indicates correction decoding, the packet identification accumulation unit 22 can take either a method of transferring the information packet to the correction-coding consecutive-transmission determination unit 21 after waiting for the result of the correction decoding unit 32 while accumulating the received information packet or a method of creating a duplicate copy of the information packet when the sequence number is contiguous, accumulating one information packet for decoding and immediately transferring the other information packet to the correction-coding consecutive-transmission determination unit 21.

The timer unit 25 is used for setting the timing for coding to insert dummy information into an information packet or timing for decoding of a missing information packet in the correction-coding control unit 23 as described above.

Next, when the correction-coding consecutive-transmission determination unit 21 determines to execute the consecutive transmission, the packet identification accumulation unit 22 performs packet identification to determine whether to perform consecutive-transmission transmission or consecutive-transmission reception of a packet acquired from the correction-coding consecutive-transmission determination unit 21. Specifically, the packet identification accumulation unit 22 outputs information packets, which are to be transmitted from the own wireless device to the multicast terminals, to the consecutive-transmission transmission unit 41 for consecutive-transmission transmission and outputs multicast packets, which are received by the own wireless device from the multicast terminals, to the consecutive-transmission reception unit 42 for consecutive-transmission reception.

When the packet identification indicates consecutive-transmission transmission, the packet identification accumulation unit 22 outputs an information packet to the consecutive-transmission transmission unit 41.

The packet identification accumulation unit 22 adds information necessary for decoding as a header to a multicast packet to which a coded packet duplicated by the consecutive-transmission transmission unit 41 for the information packet has been added, and outputs the header-added multicast packet to the correction-coding consecutive-transmission determination unit 21. The correction-coding consecutive-transmission determination unit 21 outputs the acquired multicast packet to the MAC unit 4.

FIG. 5 is a diagram illustrating a configuration example of header information added by the packet identification accumulation unit 22 in the case of consecutive transmission. Header information elements in the case of consecutive transmission include the number of information packets, the number of consecutive transmission packets, a sequence number to be used for ordering of packet missing, coding, and decoding, and the data length for adding or deleting Padding to or from variable data. The header information is required when decoding is performed in multicast terminals that have received the multicast packet.

Meanwhile, when the packet identification indicates consecutive-transmission reception, the packet identification accumulation unit 22 deletes the header after having extracted information necessary for decoding, and outputs an information packet and a coded packet having received by the own wireless device together with the extracted information to the consecutive-transmission reception unit 42.

The packet identification accumulation unit 22 outputs an information packet complemented in the consecutive-transmission reception unit 42 to the correction-coding consecutive-transmission determination unit 21. The correction-coding consecutive-transmission determination unit 21 outputs the acquired information packet to the bridge unit 6.

As described above, according to the present embodiment, when an information packet is to be transmitted by multicast, the wireless device executes control to dynamically switch whether to transmit the information packet by correction coding or transmit the information packet by consecutive transmission from the own wireless device based on a state of communication with multicast terminals as packet destinations. Accordingly, the wireless device that executes the FEC control can realize a low delay while ensuring the reliability at the time of packet transmission.

### Second Embodiment

In a second embodiment of the present invention, a determination algorithm related to switching between the correction coding and the consecutive transmission in the correction-coding consecutive-transmission determination unit 21 is specifically described.

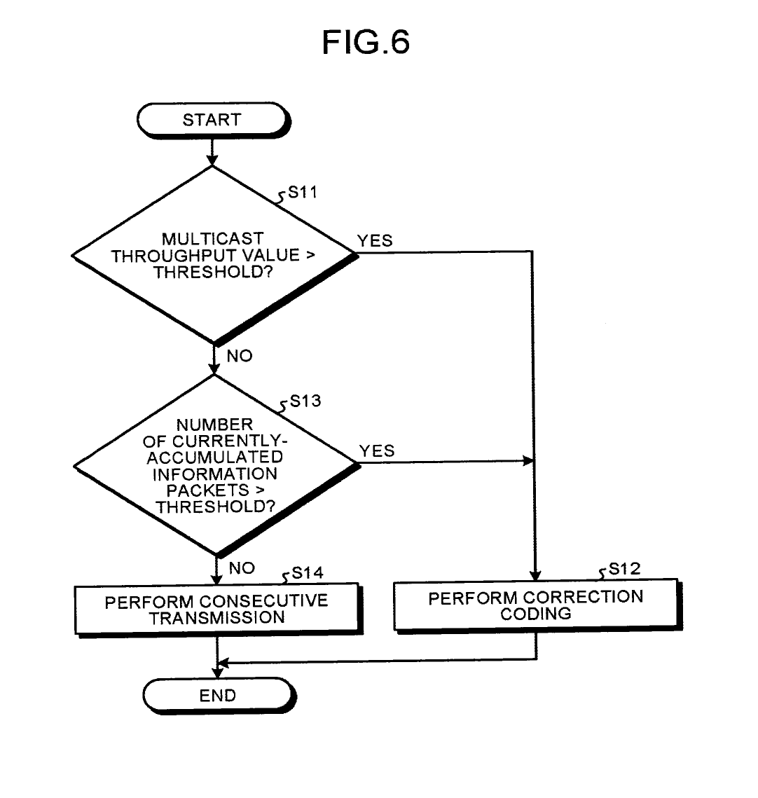

FIG. 6 is a flowchart illustrating the determination algorithm of the correction-coding consecutive-transmission determination unit 21 according to the present embodiment. First, the correction-coding consecutive-transmission determination unit 21 compares a multicast throughput value obtained from the MAC unit 4 with a throughput threshold predetermined in advance so as to determine as to which of the correction coding and the consecutive transmission should be performed (Step S11).

When the multicast throughput value is larger (YES at Step S11), the correction-coding consecutive-transmission determination unit 21 determines to transmit by the correction coding (Step S12). The correction-coding consecutive-transmission determination unit 21 determines that the information packet can be transmitted within an assumed delay when the multicast throughput value is larger than the throughput threshold and instructs the packet identification accumulation unit 22 to transfer the information packet to the correction coding unit 31.

When the multicast throughput value is equal to or smaller than the throughput threshold (NO at Step S11), the correction-coding consecutive-transmission determination unit 21 then compares the number of information packets directed to the multicast terminals, which have been currently accumulated in the packet identification accumulation unit 22, with a threshold of the number of packets (hereinafter, “packet number threshold”) predetermined in advance so as to determine as to which of the correction coding and the consecutive transmission should be performed (Step S13).

When the number of currently-accumulated information packets is larger (YES at Step S13), the correction-coding consecutive-transmission determination unit 21 determines to transmit the information packet by the correction coding (Step S12). Also in this case, the correction-coding consecutive-transmission determination unit 21 similarly instructs the packet identification accumulation unit 22 to transfer the information packet to the correction coding unit 31.

On the other hand, when the number of currently-accumulated information packets is equal to or smaller than the packet number threshold (NO at Step S13), the correction-coding consecutive-transmission determination unit 21 determines to transmit the information packet by the consecutive transmission (Step S14). The correction-coding consecutive-transmission determination unit 21 instructs the packet identification accumulation unit 22 to transfer the information packet to the consecutive-transmission transmission unit 41.

The correction-coding consecutive-transmission determination unit 21 can arbitrarily set the throughput threshold and the packet number threshold, and further, the level for determining as to which of the correction coding and the consecutive transmission should be performed can be adjusted.

Specifically, as described above, according to the present embodiment, the wireless device determines that transmission can be performed within an assumed delay and performs transmission by the correction coding when the throughput to or from the multicast terminals is larger than the predetermined threshold, and determines the correction coding or the consecutive transmission according to the number of currently-accumulated information packets when the throughput to or from the multicast terminals is equal to or smaller than the predetermined threshold. Accordingly, the wireless device that executes the FEC control can realize a low delay while ensuring the reliability at the time of packet transmission.

### Third Embodiment

In a third embodiment of the present invention, a determination algorithm different from that in the second embodiment is described.

In the present embodiment, the correction-coding consecutive-transmission determination unit 21 executes control to sort packets into the correction coding or the consecutive transmission according to the QoS class attached to the corresponding multicast traffic, which is described in Non Patent Literature listed below.

Non Patent Literature, IEEE 802.11-2012 IEEE Standard for information technology-Telecommunications and information exchange between systems-Local and metropolitan area networks-Specific requirements Part 11: Wireless LAN Medium Access Control (MAC) and Physical Layer (PHY) Specifications.

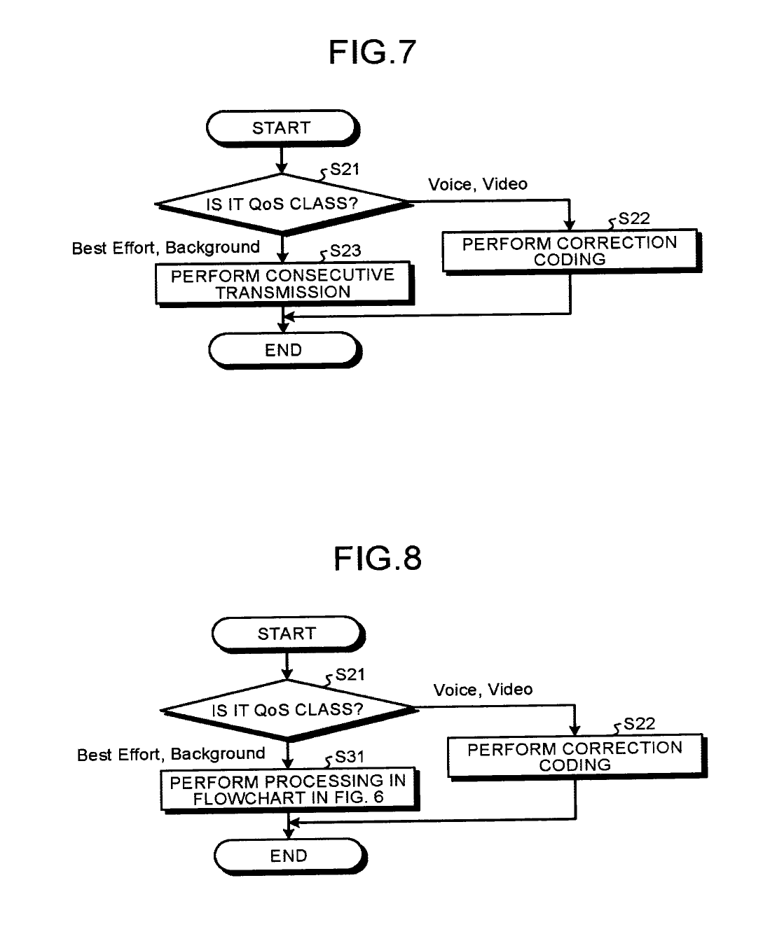

FIG. 7 is a flowchart illustrating a determination algorithm of the correction-coding consecutive-transmission determination unit 21 according to the present embodiment. First, the correction-coding consecutive-transmission determination unit 21 checks the QoS class of an information packet to be transmitted (Step S21).

When the QoS class is Voice or Video (Voice, Video at Step S21), the correction-coding consecutive-transmission determination unit 21 determines to perform transmission by the correction coding (Step S22). With respect to an information packet of Voice or Video, which can be assumed to come at a fixed rate, the correction-coding consecutive-transmission determination unit 21 instructs the packet identification accumulation unit 22 to transfer the information packet to the correction coding unit 31.

On the other hand, when the QoS class is Best Effort or Background (Best Effort, Background at Step S21), the correction-coding consecutive-transmission determination unit 21 determines to perform transmission by the consecutive transmission (Step S23). With respect to an information packet of Best Effort or Background, which cannot be assumed to come at a fixed rate, the correction-coding consecutive-transmission determination unit 21 instructs the packet identification accumulation unit 22 to transfer the information packet to the consecutive-transmission transmission unit 41.

As described above, according to the present embodiment, the wireless device determines the correction coding or the consecutive transmission based on the QoS class of an information packet. Also in this case, the wireless device that executes the FEC control can realize a low delay while ensuring the reliability at the time of packet transmission.

### Fourth Embodiment

In a fourth embodiment of the present invention, control in a case where the determination algorithms according to the second and third embodiments mentioned above are combined is described.

FIG. 8 is a flowchart illustrating a determination algorithm of the correction-coding consecutive-transmission determination unit 21 according to the present embodiment. First, the correction-coding consecutive-transmission determination unit 21 checks the QoS class of an information packet to be transmitted (Step S21). When the QoS class is Voice or Video (Voice, Video at Step S21), the correction-coding consecutive-transmission determination unit 21 determines to perform transmission by the correction coding (Step S22).

On the other hand, when the QoS class is Best Effort or Background (Best Effort, Background at Step S21), the correction-coding consecutive-transmission determination unit 21 then performs processing of the flowchart illustrated in FIG. 6 described in the second embodiment (Step S31).

In this manner, the correction-coding consecutive-transmission determination unit 21 executes the sort control described in the third embodiment and thereafter executes the control described in the second embodiment on an information packet of Best Effort or Background that cannot be assumed to be received at a fixed rate in combination. That is, after the QoS class determination described in the third embodiment indicates Best Effort or Background, the correction-coding consecutive-transmission determination unit 21 executes the control described in the second embodiment.

As described above, according to the present embodiment, the wireless device determines the correction coding or the consecutive transmission of an information packet having the QoS class of Best Effort or Background further based on the multicast throughput value and the number of currently-accumulated information packets described in the second embodiment. Accordingly, transmission control according to the quality class can be executed.

### Fifth Embodiment

In the first to fourth embodiments, the correction-coding consecutive-transmission determination unit 21 performs determination to switch between the correction coding and the consecutive transmission based on information that can be acquired in the own wireless device. In a fifth embodiment of the present invention, the correction-coding consecutive-transmission determination unit 21 determines to perform the correction coding or the consecutive transmission using feedback information acquired from the multicast terminals.

In the present embodiment, the correction-coding consecutive-transmission determination unit 21 of the FEC control unit 5 has a statistic function of acquiring information of following three parameters fed back from the multicast terminals and holding the information therein as a reception-side function, and a function of determining the correction coding or the consecutive transmission using the feedback information from the multicast terminals as a transmission-side function.

(1) Packet error rate . . . . The packet error rate is measured on the side of the multicast terminals.

(2) Burst-error duration time . . . . Missing sequence numbers of multicast packets are detected and the duration time of a packet error is measured on the side of the multicast terminals.

(3) Transfer delay time . . . . The transfer delay time is measured using a time stamp attached to multicast packets or the like on the side of the multicast terminals.

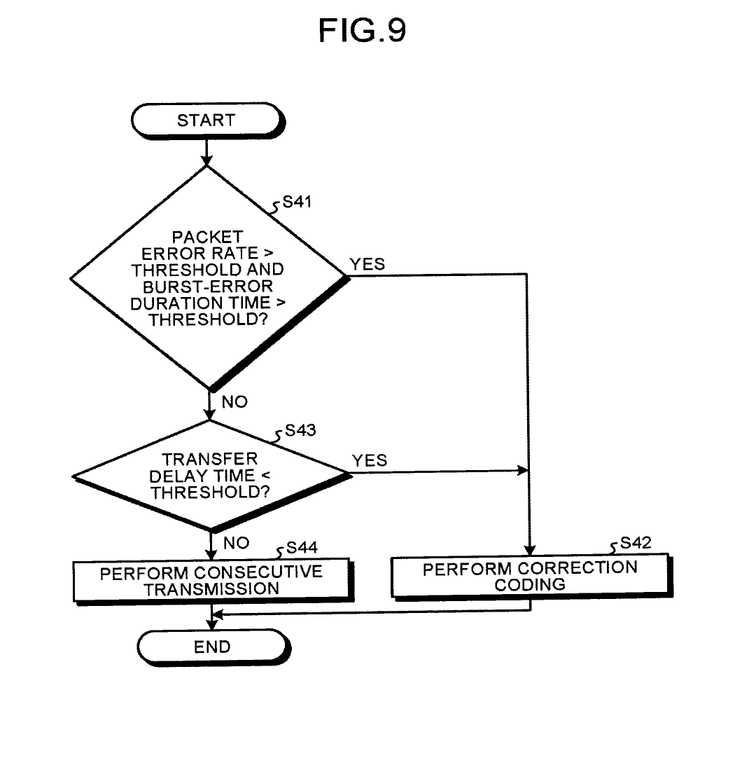

FIG. 9 is a flowchart illustrating a determination algorithm of the correction-coding consecutive-transmission determination unit 21 according to the present embodiment. Processing of determining the correction coding or the consecutive transmission in a case where the parameters (1) to (3) mentioned above are used is illustrated. First, the correction-coding consecutive-transmission determination unit 21 compares (1) the packet error rate and (2) the burst-error duration time with respective thresholds (Step S41).

When the packet error rate is larger than a packet error rate threshold predetermined in advance and the burst-error duration time is larger than a burst-error duration time threshold predetermined in advance in a relevant multicast terminal (YES at Step S41), the correction-coding consecutive-transmission determination unit 21 determines to perform transmission by the correction coding (Step S42). The correction-coding consecutive-transmission determination unit 21 instructs the packet identification accumulation unit 22 to transfer the information packet to the correction coding unit 31.

When the packet error rate in a relevant multicast terminal is equal to or smaller than the packet error rate threshold and/or when the packet-error duration time is equal to or smaller than the burst-error duration time threshold (NO at Step S41), the correction-coding consecutive-transmission determination unit 21 then compares (3) the transfer delay time with a transfer delay time threshold predetermined in advance (Step S43).

When the transfer delay time in a relevant multicast terminal is smaller than the transfer delay time threshold (YES at Step S43), the correction-coding consecutive-transmission determination unit 21 determines to perform transmission by the correction coding (Step S42). The correction-coding consecutive-transmission determination unit 21 instructs the packet identification accumulation unit 22 to transfer the information packet to the correction coding unit 31.

On the other hand, when the transfer delay time in a relevant multicast terminal is equal to or larger than the transfer delay time threshold (NO ate Step S43), the correction-coding consecutive-transmission determination unit 21 determines to perform transmission by the consecutive transmission (Step S44). The correction-coding consecutive-transmission determination unit 21 instructs the packet identification accumulation unit 22 to transfer the information packet to the consecutive-transmission transmission unit 41.

Similarly to the second embodiment, the packet error rate threshold, the burst-error duration time threshold, and the transfer delay time threshold can be arbitrarily set. The level for determining as to which of the correction coding and the consecutive transmission should be performed can be adjusted.

As describe above, in the present embodiment, the wireless device determines the correction coding or the consecutive transmission based on the feedback information acquired from the multicast terminals that are destinations of multicast packets. Accordingly, the correction coding or the consecutive transmission can be determined according to the reception state of the multicast terminals.

### Sixth Embodiment

In a sixth embodiment of the present invention, a case where the ARQ is combined with the operation described in the fifth embodiment is described.

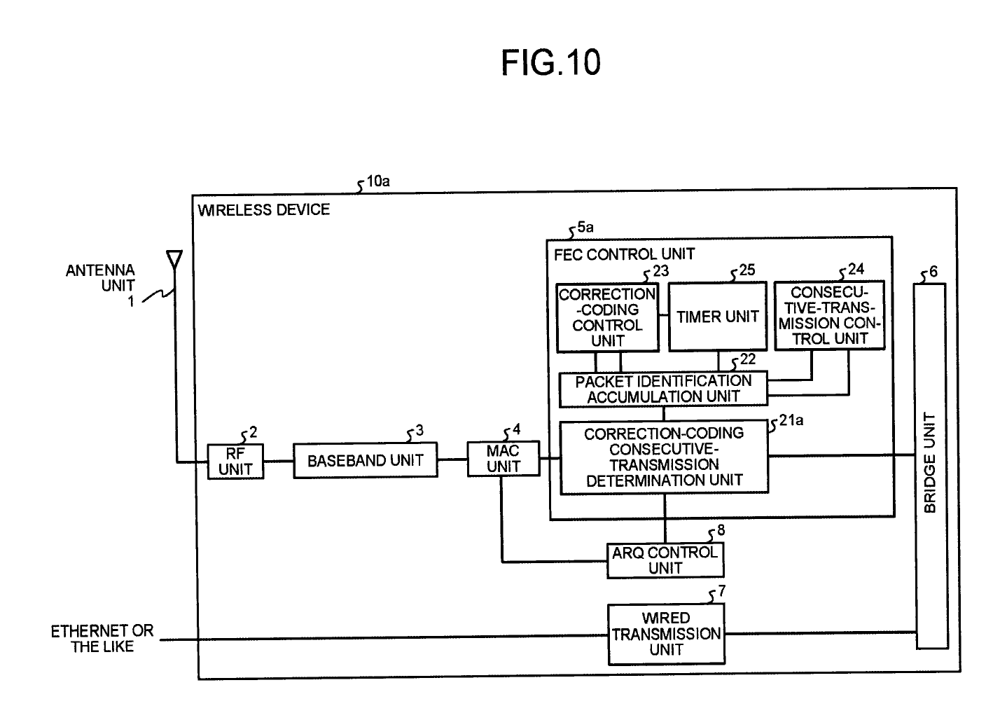

FIG. 10 is a diagram illustrating a configuration example of a wireless device that performs communication via a wireless LAN according to the present embodiment. A wireless device 10a includes the antenna unit 1, the RF unit 2, the baseband unit 3, the MAC unit 4, an FEC control unit 5a that determines whether to correction-code or consecutive-transmit an information packet to be transmitted, the bridge unit 6, the wired transmission unit 7, and an ARQ control unit 8 that executes retransmission control by ARQ.

The FEC control unit 5a includes a correction-coding consecutive-transmission determination unit 21a that determines whether to correction-code or consecutive-transmit an information packet of a multicast packet transmitted from the antenna unit 1, the packet identification accumulation unit 22, the correction-coding control unit 23, the consecutive-transmission control unit 24, and the timer unit 25.

As illustrated in FIG. 10, the ARQ control unit 8 connects the MAC unit 4 and the correction-coding consecutive-transmission determination unit 21a of the FEC control unit 5a with each other.

While releasing accumulated information packets after transmission under the FEC control in the first embodiment, the packet identification accumulation unit 22 according to the present embodiment does not release accumulated information packets even after transmission under the FEC control when the ARQ control is ON.

When the ARQ control is ON, information of a missing sequence number and a retransmission request necessary for the ARQ control is added to feedback information from a multicast terminal to the correction-coding consecutive-transmission determination unit 21a, in addition to the three parameters described in the fifth embodiment.

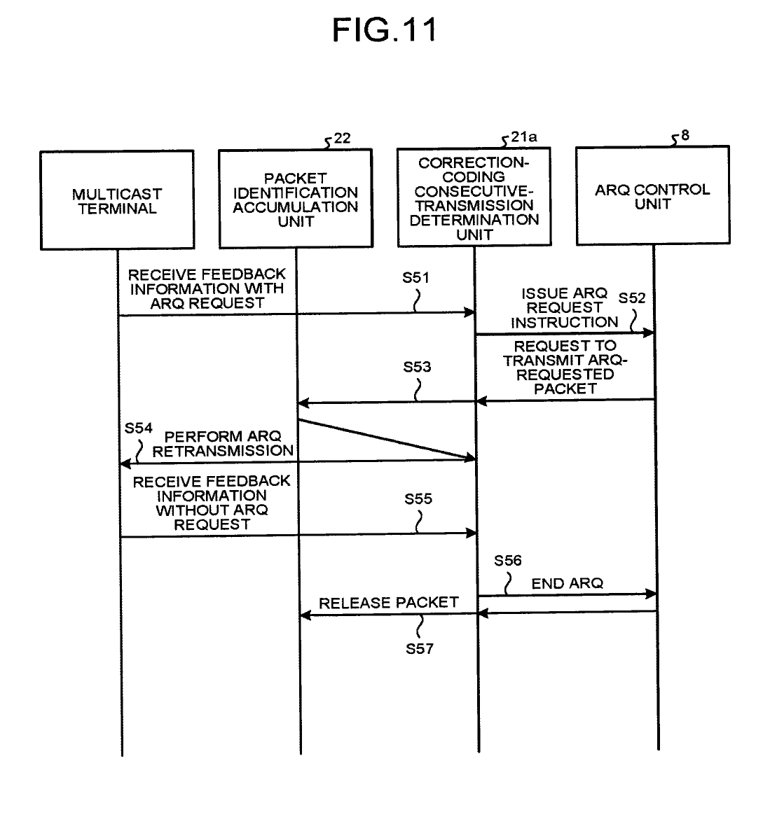

An operation of the wireless device associated with the ARQ control is described next. FIG. 11 is a sequence diagram illustrating retransmission control by the ARQ in the wireless device according to the present embodiment. First, when the feedback information is received by the wireless device 10a from a multicast terminal, this implies that the correction-coding consecutive-transmission determination unit 21a of the FEC control unit 5a receives the feedback information with an ARQ request (Step S51) and thus the correction-coding consecutive-transmission determination unit 21a issues an ARQ request instruction to the ARQ control unit 8 (Step S52).

The ARQ control unit 8 instructs the packet identification accumulation unit 22 via the correction-coding consecutive-transmission determination unit 21a of the FEC control unit 5a to retransmit a multicast packet including a missing information packet (Step S53). The packet identification accumulation unit 22 executes control to transmit (ARQ retransmit) a multicast packet including information packets accumulated therein to the corresponding multicast terminal via the correction-coding consecutive-transmission determination unit 21a (Step S54).

When the retransmission is performed successfully, the correction-coding consecutive-transmission determination unit 21a in the wireless device 10a receives feedback information without an ARQ request from the multicast terminal (Step S55). In this case, the correction-coding consecutive-transmission determination unit 21a instructs the ARQ control unit 8 to finish the ARQ (Step S56). The ARQ control unit 8 instructs the packet identification accumulation unit 22 via the correction-coding consecutive-transmission determination unit 21a of the FEC control unit 5a to release the accumulated information packets (Step S57).

In this manner, the wireless device can also address the ARQ control and perform retransmission under the ARQ control when an ARQ request is received from a multicast terminal.

### INDUSTRIAL APPLICABILITY

As described above, the wireless device according to the present invention is useful in wireless communication and is particularly suitable for multicast communication.

### REFERENCE SIGNS LIST

antenna unit, 2 RF unit, 3 baseband unit, 4

MAC unit, 5, 5a FEC control unit, 6 bridge unit, 7 wired transmission unit, 8 ARQ control unit, 10, 10a wireless device, 21, 21a correction-coding consecutive-transmission determination unit, 22 packet identification accumulation unit, 23 correction-coding control unit, 24 consecutive-transmission control unit, 25 timer unit, 31 correction coding unit, 32 correction decoding unit, 41 consecutive-transmission transmission unit, 42 consecutive-transmission reception unit.

1. A wireless device comprising: a correction-coding consecutive-transmission determinator that determines as to which of correction-coding and consecutive-transmission of information packets should be transmitted, based on information of a communication state with a packet destination terminal;
a packet identification accumulator that identifies and accumulates information packets acquired from the correction-coding consecutive-transmission determinator;
a correction-coding controller that performs correction coding and correction decoding of information packets acquired from the identification accumulator; and
consecutive-transmission controller that duplicates and complements the information packets acquired from the packet identification accumulator,
wherein the correction-coding consecutive-transmission determinator performs determination based on either information of throughput between the packet destination terminal and the wireless device itself, or information of a number of information packets accumulated in the packet identification accumulator.

2-4. (canceled)

5. The wireless device according to claim 1, wherein when the correction-coding consecutive-transmission determinator determines to perform correction coding,
the packet identification accumulator outputs accumulated information packets to the correction-coding controller after accumulating a predetermined number of information packets, and
the correction-coding controller adds coded packets to the acquired information packets and combines the information packets and the coded packets to form multicast packets to be transmitted to the packet destination terminals, respectively.

6. The wireless device according to claim 5, further comprising a timer that measures a time during which information packets are accumulated in the packet identification accumulator, wherein
the packet identification accumulator inserts a dummy information packet into the accumulated information packets and outputs the information packets to the correction-coding controller after a predetermined time has passed from the start of accumulation of information packets through measurement of the timer.

7. The wireless device according to claim 1, wherein when a multicast packet to which correction coding is applied and in which an information packet is missing is received,
the correction-coding consecutive-transmission determinator outputs the received multicast packet to the packet identification accumulator,
the packet identification accumulator accumulates an information packet and a coded packet included in the acquired multicast packet, and, after accumulating predetermined number of coded packets, outputs the accumulated coded packets together with information packets that have been successfully received and accumulated to the correction-coding controller, and
the correction-coding controller decodes the missing information packet using the acquired information packets and coded packets.

8. The wireless device according to claim 7, further comprising a timer that measures a time during which coded packets are accumulated in the packet identification accumulator, wherein
the packet identification accumulator outputs accumulated coded packets to the correction-coding controller after a predetermined time has passed from the start of accumulation of coded packets through measurement of the timer.

9. The wireless device according to claim 1, wherein when the correction-coding consecutive-transmission determinator determines to perform consecutive transmission,
the packet identification accumulator outputs the information packet to the consecutive-transmission controller, and
the consecutive-transmission controller duplicates the acquired information packet as a coded packet and combines the information packet and the coded packet to form a multicast packet to be transmitted to the packet destination terminals, respectively.

10. The wireless device according to claim 1, wherein when a multicast packet to which consecutive transmission is applied and in which an information packet is missing is received,
the correction-coding consecutive-transmission determinator outputs the received multicast packet to the packet identification accumulator,
the packet identification accumulator outputs a coded packet included in the acquired multicast packet to the consecutive-transmission controller, and
the consecutive-transmission controller complements the missing information packet using the acquired coded packet.

11. The wireless device according to any one of claims 1 claim 1, further comprising an ARQ controller that executes ARQ retransmission control, wherein
when an ARQ request is received from one of the packet destination terminals,
the ARQ controller executes control to retransmit information packets accumulated in the packet identification accumulator.
